(19) United States
(12) Patent Application Publication
(10) Pub. No.: US 2004/0149714 A1
(43) Pub. Date: Aug. 5, 2004

(54) Apparatus and method for temperature control in rtp using an adaptive control

(76) Inventors: Jim-Young Choi, Seoul (KR); Hong-Seok Choi, Seoul (KR); Hyun-Mi Do, Seoul (KR)

Correspondence Address: MARGER JOHNSON & MCCOLLOM PC, 1030 SW MORRISON STREET, PORTLAND, OR, 97205, US

(21) Appl. No.: 10/472,735

(22) PCT Filed: Mar. 21, 2001
(86) PCT No.: PCT/KR01/00443

(51) Int. Cl. F27D 11/00; F27B 5/14

(52) U.S. Cl. 219/390; 219/411; 392/418

(57) ABSTRACT

Apparatus and method for temperature control in a rapid thermal processing(RTP) system using an adaptive control are disclosed. The apparatus of the present invention is comprised of a controller, a nonlinear dynamic estimator, and a parameter adaptator as a whole. The parameter adaptator reflects tracking errors between desired output and actual output to vary parameters, and the nonlinear dynamic estimator enables on-line identification of the dynamic characteristics of the system using the varied parameters. The controller generates the control input on the basis of the estimated values to perform the control of the system. According to the present invention, in the temperature control of a RTP system an accurate output tracking to a reference trajectory can be achieved by on-line identification of system dynamics and adaptive control even though system model is unknown or system characteristics are time-varying.

### TECHNICAL FIELD

The present invention relates to an apparatus and a method for temperature control in a rapid thermal processing system using an adaptive control.

### BACKGROUND ART

Rapid thermal processing system is a single-type wafer processing apparatus which can perform various process steps upon a wafer rapidly during the manufacture of semiconductor devices. Therefore, in a rapid thermal processing system temperature of a wafer should be controlled precisely in a short period. The purpose of temperature control in a rapid thermal processing system is to have the temperature of a wafer precisely follow the temperature curve defined in a manufacturing process, and to keep a uniform temperature distribution on a wafer with minimal variation.

In early days, the control of a rapid thermal processing system was to use PID control by attaching a single lamp group and a single sensor. According to the development of multi variables control technique, the lamp group has been separated and temperatures at several spots on a wafer has been detected. Norman proposed a lamp structure having a triple ring as disclosed in reference 1, and analyzed an error limit of a system by applying a linear programming to its mathematical model (Reference 1: S. A. Norman, “Optimization of Wafer temperature Uniformity in Rapid Thermal Processing Systems,” Technical report, Dept. of Electrical Engineering, Stanford University, June, 1991). However, this method is based on a precise mathematical model and its performance can be lowered in a real system due to the difference between a model and a real system. On the other hand, Schaper, et. al. constructed a controller by combining a feedforward controller which predicts a control input on-line, a feedback controller which compensates a modeling error and disturbance, and a gain scheduling method to overcome nonlinearity as disclosed in reference 2 (Reference 2: C. Schaper, Y. Cho, P. Park, S. Norman, P. Gyugi, G. Hoffman, S. Boyd, G. Franklin, T. Kailath, and K. Saraswat, “Modeling and Control of Rapid Thermal Processing,” In SPIE Rapid Thermal and Integrated Processing, September, 1991). The performance of such a controller is determined by parameters of the controller, but it is difficult to respond effectively when system characteristics change due to the absences of a systematic method to define parameters. Despite of continuous researches, the dependence on a system model has potential problems of degraded performance due to a modeling error and time-varying characteristics in real applications.

### DISCLOSURE OF THE INVENTION

Therefore, it is an object of the present invention to provide an apparatus and a method for temperature control which can track a reference trajectory precisely through an adaptive control by on-line identification of system dynamics even though a system model is unknown or system characteristics is time-varying when controlling the temperature of a rapid thermal processing system.

The temperature control apparatus of the rapid thermal processing system of the present invention is to control power of a lamp in order to provide a uniform temperature distribution across a wafer with minimal temperature variation while the temperature of a wafer tracks precisely the temperature curve defined in a manufacturing process at the same time in a rapid thermal processing system. The temperature control apparatus of the present invention comprises: a controller which calculates a proper power of a lamp using an approximated feedback linearization; a nonlinear dynamic estimator which estimates unknown dynamic portion of the processing system on-line; and a parameter adaptator which adapts parameters of the nonlinear dynamic estimator.

Furthermore, the method of temperature control of the present invention is performed in the above apparatus. The method of temperature control of the present invention comprises the steps of: changing parameters reflecting tracking errors between a real output and a desired output in the parameter adaptator; identifying the dynamic characteristics of the system in the nonlinear dynamic estimator using the parameters; and performing temperature control of the rapid thermal processing system by obtaining a control input in the controller based on the estimated values.

### BRIEF DESCRIPTION OF THE DRAWINGS

FIG. 1 is a block diagram of a temperature control for a rapid thermal processing system according to the present invention;

FIG. 2 is a schematic cross section of a common rapid thermal processing system;

FIG. 3a is an overall structure of a triple ring type rapid thermal processing system to which an example of the present invention is applied;

FIG. 3b is a bottom view of a lamp ring contained in the rapid thermal processing system of FIG. 3a and a schematic cross section of the processing system;

FIG. 4 is a graph showing a reference temperature trajectory to verify embodiment 1 according to present invention;

FIG. 5 is a graph showing an average output error from three spots upon time in the embodiment 1;

FIG. 6 is a graph showing each input in the embodiment 1;

FIG. 7 is a graph showing a temperature uniformity error in the embodiment 1;

FIG. 8 is a diagram showing a result from method described in the embodiment 1 when 10% variation in a model parameter of a system is applied to verify adaptation capability of a proposed controller under system variation;

FIG. 9 is a graph showing a reference output and a real output together when the steady state temperature of a desired reference output in embodiment 2 is 1000° C.;

FIG. 10 is a graph showing an input in FIG. 9;

FIG. 11 is a graph showing a real output when the steady state temperature of a reference output is 900° C.;

FIG. 12 is a graph showing an input in FIG. 11;

FIG. 13 is a graph showing a real output when the steady state temperature of a reference output is 800° C.; and

FIG. 14 is a graph showing an input in FIG. 13.

### BEST MODE FOR CARRYING OUT THE INVENTION

The preferred embodiments of the present invention will be described hereinafter with reference to the accompanying drawings. The apparatus according to the present invention comprises a controller, a nonlinear dynamic estimator and a parameter adaptator. Detailed explanation on the elements is given below separately.

[Controller]

A schematic diagram of a common rapid thermal processing system is shown in FIG. 2. If the temperature of a wafer in the processing system is measured in n spots, and the number of inputs or lamps are m, then temperatures of the n spots on a wafer are modeled as an affine nonlinear system as the following Mathematical equation 1.

$$[ Mathematical equation 1 ]$$

$${\dot{T}}_{1} = {f}_{1} ( {T}_{1} , {T}_{2} , ⋯ , {T}_{n} ) + {\sum }_{j = 1}^{m} {g}_{1 j} ( {T}_{1} , {T}_{2} , ⋯ , {T}_{n} ) {P}_{j}$$

$$⋮ ⋮$$

$${\dot{T}}_{n} = {f}_{n} ( {T}_{1} , {T}_{2} , ⋯ , {T}_{n} ) + {\sum }_{j = 1}^{m} {g}_{nj} ( {T}_{1} , {T}_{2} , ⋯ , {T}_{n} ) {P}_{j}$$

In the above Mathematical equation 1, Tᵢ is the temperature at i-th position of the wafer, Pⱼ is the power of j-th lamp or an control input (but, 1≦i≦n, 1≦j≦m, m≦n). Suppose that temperature of a wafer on each spot is uniform, or, T₁≈T₂≈ . . . ≈Tₙ, the i-th equation of the Mathematical equation becomes the following Mathematical equation 2.

$${\dot{T}}_{1} = {f}_{i} ( {T}_{i} ) + {\sum }_{j = 1}^{m} {g}_{ij} ( {T}_{i} ) {P}_{j} + {\tilde{n}}_{i} ( t ) \qquad [ Mathematical equation 2 ]$$

In the Mathematical equation 2, ñᵢ(t) is an error when the temperature on a wafer is uniform. As shown in the following Mathematical equation 3, when a temperature of a wafer position closest to each lamp is selected as an output temperature to be controlled among temperatures on a wafer, the number of inputs and outputs shall be equal to m, and then the Mathematical equation 2 shall be expressed as Mathematical equation 4.

$$\begin{matrix}[ \begin{matrix}{x}_{1} \\ {x}_{2} \\ ⋮ \\ {x}_{m}\end{matrix} ] = [ \begin{matrix}1 & 0 & 0 & ⋯ & 0 & 0 & 0 \\ 0 & 0 & 1 & ⋯ & 0 & 0 & 0 \\ & & & ⋮ & & & \\ 0 & 0 & 0 & ⋯ & 0 & 0 & 1\end{matrix} ] [ \begin{matrix}{T}_{1} \\ {T}_{2} \\ ⋮ \\ {T}_{n}\end{matrix} ] & [ Mathematical equation 3 ] \\ {\dot{x}}_{i} = {f}_{i} ( {x}_{i} ) + {g}_{ii} ( {x}_{i} ) {P}_{i} + {\sum }_{j = 1 , j \neq i}^{m} {g}_{ij} ( {x}_{i} ) {P}_{j} + {\tilde{n}}_{i} ( t ) & [ Mathematical equation 4 ]\end{matrix}$$

In the Mathematical equation 4, 1≦i≦n. Suppose that the influence of Pᵢ on xᵢ is big enough so that

$${\sum }_{j = 1 , j \neq i}^{m} {g}_{ij} ( {x}_{i} ) {P}_{j}$$

is very small compared to gᵢᵢ(xᵢ)Pᵢ and define an uncertainty term

$${n}_{i} ( t ) = {\tilde{n}}_{i} ( t ) + {\sum }_{j = 1 , j \neq i}^{m} {g}_{ij} ( {x}_{i} ) {P}_{j} ,$$

then following Mathematical equation 5 can be obtained.

\dot{x}ᵢ=ƒᵢ(xᵢ)+gᵢᵢ(xᵢ)Pᵢ+nᵢ(t) [Mathematical equation 5]

When only a part of nonlinear dynamics ƒᵢ(xᵢ) and gᵢ(xᵢ) of a system are known, then the unknown parts of ƒᵢ(xᵢ)+nᵢ(t) and gᵢ(xᵢ) are estimated to be \hat{ƒ}ᵢ(xᵢ), ĝᵢ(xᵢ) using input and output data. There is no interference in each equation and a design of a controller is possible. Therefore, hereinafter the subscript (i) is omitted. Since each function ƒ(x)+n(t), g(x) is not known precisely, a controller is constructed based on estimated values. The controller is described in the following Mathematical equation 6.

$${P}_{ad} = \frac{1}{\hat{g} ( x )} ( - \hat{f} ( x ) + υ ( t ) ) \qquad [ Mathematical equation 6 ]$$

v(t) is designed as the following Mathematical equation 7.

v(t)=\dot{X}_{d}(t)−αe(t)tm [Mathematical equation 7]

In the Mathematical equation 7, α is a positive constant, e(t) is a tracking error and e(t)=x(t)−x_{d}(t), and x_{d}(t) is a desired system output. When a control input described in Mathematical equation 7 is applied to the system, a tracking error can be described as the Mathematical equation 8.

\dot{e}(t)+αe(t)=d(t) [Mathematical equation 8]

In the Mathematical equation 8, d(t)=(ƒ(x)+n(t)−\hat{ƒ}(x))+(g(x)−ĝ(x))P_{ad}, and when ƒ(x), g(x) are precisely estimated, d(t)=0 and the tracking error converges to 0. When there is an error in estimating ƒ(x), g(x), the tracking error will be limited to a certain degree according to the error. That is, the more precise ƒ(x), g(x) are, the smaller the tracking error.

[Nonlinear Dynamic Estimater]

In order to estimate unknown parts of ƒ(x), g(x), a nonlinear dynamic estimator is constructed as follows. Suppose that known parts of ƒ(x), g(x) are \overline{ƒ}(x), \overline{g}(x), and unknown parts are Δƒ(x), Δg(x) then the estimated values of ƒ(x), g(x) can be expressed as the following Mathematical equation 9.

\hat{ƒ}(x)=\overline{ƒ}(x)+Δ\hat{ƒ}(x), ĝ(x)=\overline{g}(x)+Δĝ(x) [Mathematical equation 9]

In the present invention, in order to estimate \hat{ƒ}(x), ĝ(x) on-line, a Piecewise Linear Approximation Network(PLAN) is used. The estimated value obtained by PLAN is given in Mathematical equation 10.

$$\begin{matrix}Δ \hat{f} ( x ) = {\sum }_{i = 1}^{{N}_{f}} ( {W}_{{f}_{i}}^{T} ( x - {c}_{{f}_{i}} ) + {b}_{{f}_{i}} ) {μ}_{{f}_{i}} ( x ) , \\ Δ \hat{g} ( x ) = {\sum }_{i = 1}^{{N}_{g}} ( {W}_{{g}_{i}}^{T} ( x - {c}_{{g}_{i}} ) + {b}_{{g}_{i}} ) {μ}_{{g}_{i}} ( x )\end{matrix} \qquad [ Mathematical equation 10 ]$$

In the Mathematical equation 10, μ_{ƒi} and μ_{gi} are localization functions based on radial basis function with C_{ƒi}, C_{gi} being the centers of the domain and it is approximated linearly in each local domain by using a linear function (w_{ƒ}_{ᵢ}^{T}(x−c_{ƒ}_{ᵢ})+b_{ƒ}_{ᵢ}). For convenience, when it is expressed without differentiating ƒ(x) and g(x), the radial basis function can be written as the following Mathematical equation 11.

$${μ}_{i}^{o} ( x ) = \{ \begin{matrix}exp ( - ‖ x - {c}_{i} ‖ when exp ( - ‖ x - {c}_{i} ‖ ) \geq v \\ \begin{matrix}0 & in other cases\end{matrix}\end{matrix} \qquad [ Mathematical equation 11 ]$$

In the Mathematical equation 11, ∥ ∥ is an arbitrary norm defined by a user, and ν is a parameter defined by a user and determines a range of local domain. However, it does not critically affect the performance. In this case, the summation of all local domains should contain estimated domain D. That is, for all x in any open set containing estimated domain

$$D , {\sum }_{j = 1}^{N} {μ}_{j}^{o} ( x ) .$$

The localization function is normalized by the following Mathematical equation 12 in order to satisfy “partitions of unity” as explained in reference 3 (reference 3: M. Spivak, Calculus on Manifold, New York: Benjamin, 1965).

$${μ}_{i} ( x ) = \frac{{μ}_{i}^{o} ( x )}{{\sum }_{j = 1}^{N} {μ}_{j}^{o} ( x )} \qquad [ Mathematical equation 12 ]$$

A norm, as one example in a radial basis function, can be expressed as Mathematical equation 13.

$$‖ x - {c}_{i} ‖ = {\sum }_{j = 1} {( {x}_{j} - {c}_{ij} )}^{2} {σ}_{j} \qquad [ Mathematical equation 13 ]$$

Here, σⱼ is set so that each function has the same value at the middle point where several localization function overlaps. That is, in the n-th dimension space, it can be defined as Mathematical equation 14.

$$exp ( - {\sum }_{j = 1}^{n} {( {Δ}_{j} / 2 )}^{2} {σ}_{j} ) = 1 / {2}^{n} \qquad [ Mathematical equation 14 ]$$

In the Mathematical equation 14, Δj is a size of a lattice of each axis.

The Mathematical equation 10 can be expressed by the following Mathematical equation 15 as a standard form.

$$\begin{matrix}Δ \hat{f} ( x ) = {φ}_{f}^{T} ( x ) {θ}_{f} , Δ \hat{g} ( x ) = {φ}_{g}^{T} ( x ) {θ}_{g} \\ {θ}_{f} = {[ {w}_{{f}_{1}}^{T} , {b}_{{f}_{1}} , … , {w}_{{f}_{{N}_{f}}}^{T} , {b}_{{f}_{{N}_{f}}} ]}^{T} \\ {θ}_{g} = {[ {w}_{{g}_{1}}^{T} , {b}_{{g}_{1}} , … , {w}_{{g}_{{N}_{g}}}^{T} , {b}_{{g}_{{N}_{g}}} ]}^{T} \\ {φ}_{f} ( x ) = [ {( x - {c}_{{f}_{1}} )}^{T} {μ}_{{f}_{1}} ( x ) , \\ {μ}_{{f}_{{N}_{f}}} ( x ) , … , \\ {( x - {c}_{{f}_{{N}_{f}}} )}^{T} {μ}_{{f}_{{N}_{f}}} ( x ) , \\ { {μ}_{{f}_{{N}_{f}}} ( x ) ]}^{T} \\ {φ}_{g} ( x ) = [ {( x - {c}_{{g}_{1}} )}^{T} {μ}_{{g}_{1}} ( x ) , \\ {μ}_{{g}_{{N}_{g}}} ( x ) , … , \\ {( x - {c}_{{g}_{{N}_{g}}} )}^{T} {μ}_{{g}_{{N}_{g}}} ( x ) , \\ { {μ}_{{g}_{{N}_{g}}} ( x ) ]}^{T}\end{matrix} \qquad [ Mathematical equation 15 ]$$

The Piecewise Linear Approximation Network is a universal approximator and, ƒ(x), g(x) can be approximated with arbitrary precision if the network is big enough.

From the Mathematical equations 9 and 15, the 24*** can be expressed as the Mathematical equation 16.

\hat{ƒ}(x)=\overline{ƒ}(x)+φ_{ƒ}^{T}(x)θ_{ƒ}, ĝ(x)=\overline{g}(x)+φ_{g}^{T}(x)θ_{g} [Mathematical equation 16]

[Parameter Adaptator]

In order to have a control input by Mathematical equation 6, the ĝ(x)≠0 in the Mathematical equation 16. That is, the following hypothesis 1 must be satisfied.

(Hypothesis 1)

There exists a constant gᵢ which satisfies the Mathematical equation 17.

ĝ(x)≧gₗ>0 [Mathematical equation 17]

When ĝ(x) is negative it can be speculated in a similar method. A parameter adaptator for parameter θ_{ƒ}, θ_{g} of the Mathematical equation 16 shall be constructed so that this condition may be satisfied. Adaptive law on θ_{ƒ} is described in the Mathematical equation 18.

$$\frac{ⅆ {θ}_{f}}{ⅆ t} = {Γ}_{f} ⅇ ( t ) {φ}_{f} ( x ) \qquad [ Mathematical equation 18 ]$$

In the Mathematical equation 18, Γ_{ƒ} is an adaptation rate.

θ_{g} is limited inside a convex set S of the Mathematical equation 19 to satisfy the Hypothesis 1.

S={θ_{g}|\tilde{g}=gₗ−ĝ(θ_{g}, x)≦0, ∀xεD} [Mathematical equation 19]

The adaptive law of θ_{g} for Mathematical equation 19 is given in the Mathematical equation 20.

$$\frac{ⅆ {θ}_{g}}{ⅆ t} = \{ \begin{matrix}{Γ}_{g} ⅇ ( t ) {φ}_{g} ( x ) {u}_{ad} & \begin{matrix}when {θ}_{g} ∈ {S}^{o} or \\ ( {θ}_{g} ∈ \overline{S} and {u}_{ad} ⅇ ( t ) \geq 0 )\end{matrix} \\ 0 & in other cases\end{matrix} \qquad [ Mathematical equation 20 ]$$

In the Mathematical equation 20, Γ_{g} is an adaptation rate, S⁰ is inside of S, \overline{S} is the border of S. Under an adaptive law given in the Mathematical equation 20, when θ_{g}(0) exists in S, θ_{g} shall not deviate out of S.

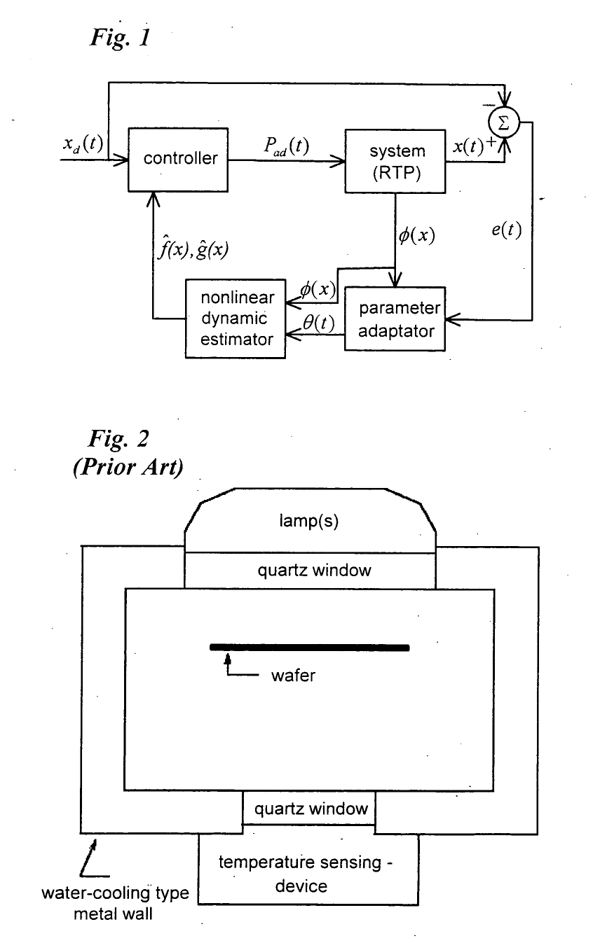

In the above explanation overall system control is accomplished as shown in FIG. 1. By reflecting tracking error between desired output and real output, a parameter is changed in a parameter adaptator, and \hat{ƒ}(x), ĝ(x) are obtained from a nonlinear dynamic estimator using it. A control input is obtained based on the estimated value in controller, and control is performed.

[Embodiment 1]

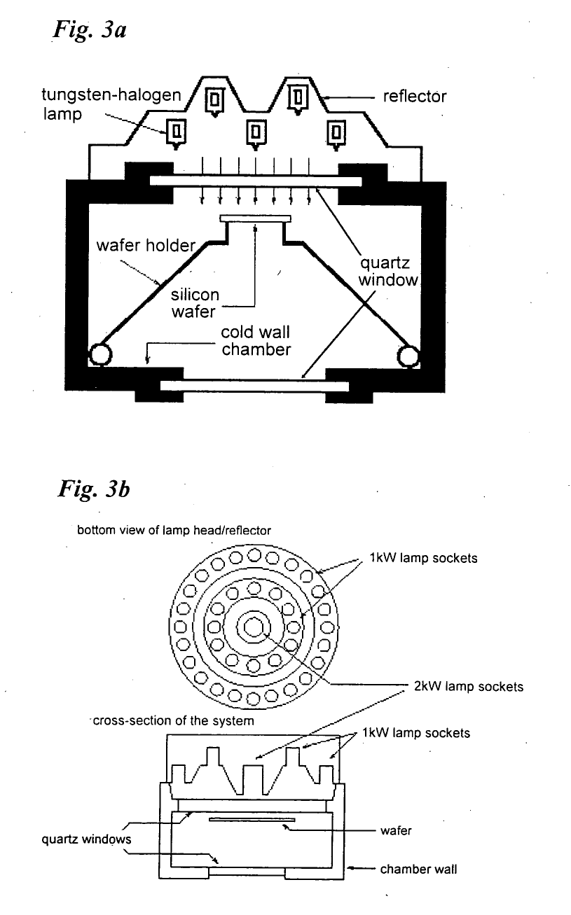

The method for temperature control in a rapid thermal processing system employing the adaptive control according to the present invention is applied to the triple ring type rapid thermal processing system proposed by Norman at Stanford University. The overall structure of the triple ring type rapid thermal processing system is shown in FIG. 3a, and a bottom view of a lamp ring and a schematic cross section of a processing system are shown in FIG. 3b.

Referring to FIGS. 3a and 3b, the present system has an input and output system with three inputs and three outputs. Three lamp rings are activated by independent inputs. Outputs are temperatures measured on twenty spots on a wafer, and in this embodiment three temperature outputs from a center, a middle point and an edge of a wafer are selected and used.

Overall model equation is given in the Mathematical equation 21.

$$\begin{matrix}q = {K}^{rad} {T}^{4} + {K}^{cond} ( T ) T + \\ {K}^{conv} ( T - [ \begin{matrix}{T}_{gas} \\ ⋮ \\ {T}_{gas}\end{matrix} ] ) + LP + {q}^{wall} + {q}^{dist} \\ \dot{T} = {C ( T )}^{- 1} q\end{matrix} \qquad [ Mathematical equation 21 ]$$

In the Mathematical equation 21, T, q, P are vectors representing temperature, hear flow and power of a lamp, respectively. Coefficients K^{rad}, K^{cond} (T) and K^{conv} are determined by a system structure. L is a constant determined by a lamp environment. C(T) is represented by a weight and specific heat capacity of a wafer. Other conditions for the simulation experiment is same with the reference 1. The conditions are set as follows: \overline{ƒ}=0, \overline{g}=5 in the Mathematical equation 16 and gₗ=1 in the Mathematical equation 17. The size of a lattice of an axis is 500° C., the number of each local domain for ƒ, g are 2 and their centers are at 600° C. and 1100° C.

In order to verify the embodiment 1 of the present invention, the reference trajectory of temperature is shown in FIG. 4. Referring to FIG. 4, the temperature stays at 600° C. for 10 seconds, rises at the rate of 100° C./s for 5 seconds and then is kept at 1100° C. followed by cooling down at the rate of −10° C./s for 50 seconds.

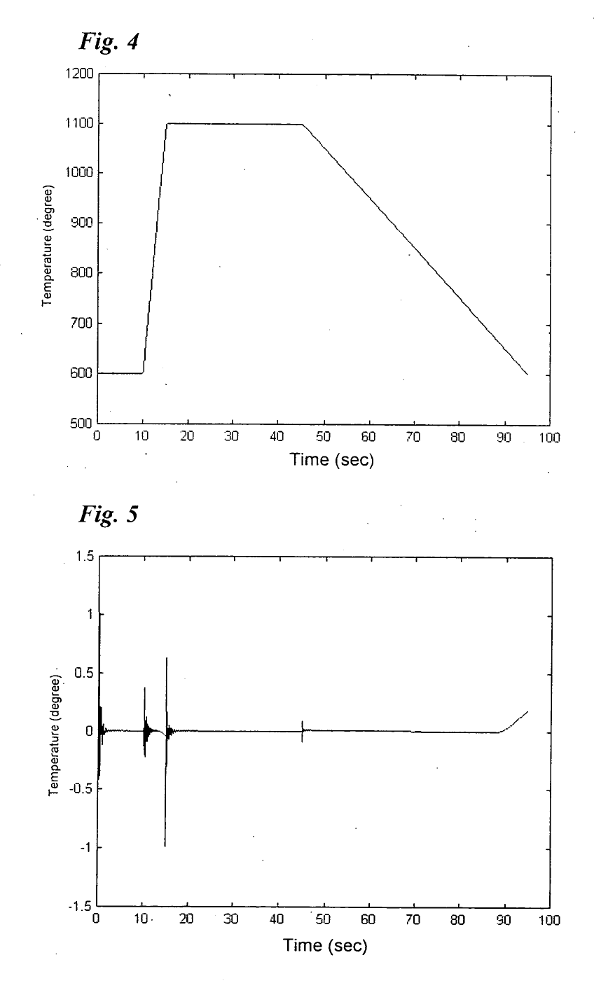

FIG. 5 is a graph showing an average output error from three spots upon time in the embodiment 1.

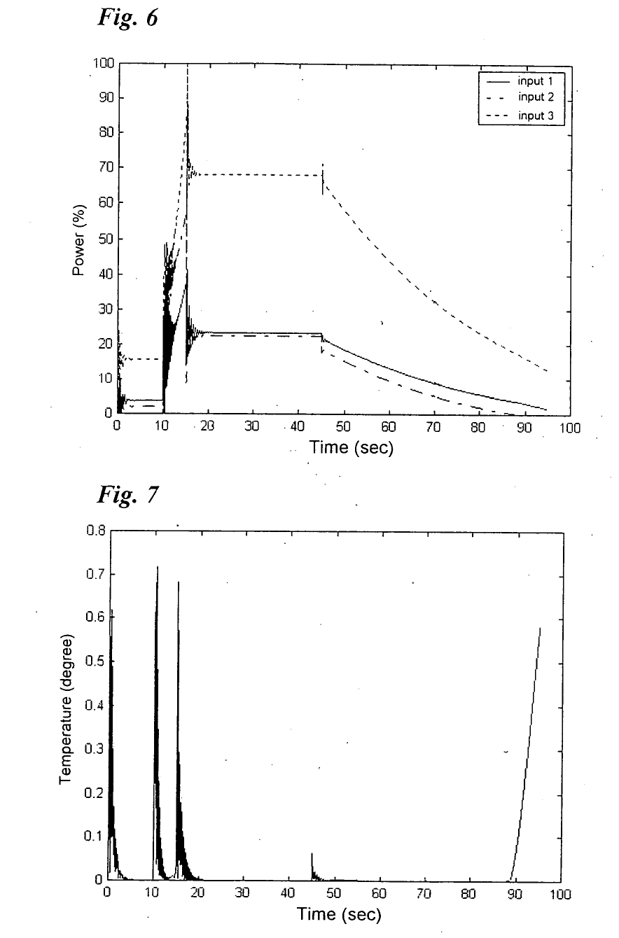

FIG. 6 is a graph showing each input in the embodiment 1. Input 1 is input on the most central lamp, input 2 is that on the middle lamp, and input 3 is that on the outermost lamp.

FIG. 7 is a graph showing a temperature uniformity error in the embodiment 1. That is, it recorded the biggest temperature difference among three outputs at each time frame. The temperature uniformity is also subject to control, and minimization of temperature uniformity error allows effective wafer processing. The results from FIG. 5 to FIG. 7 indicate that the method according to embodiment 1 provides good performance.

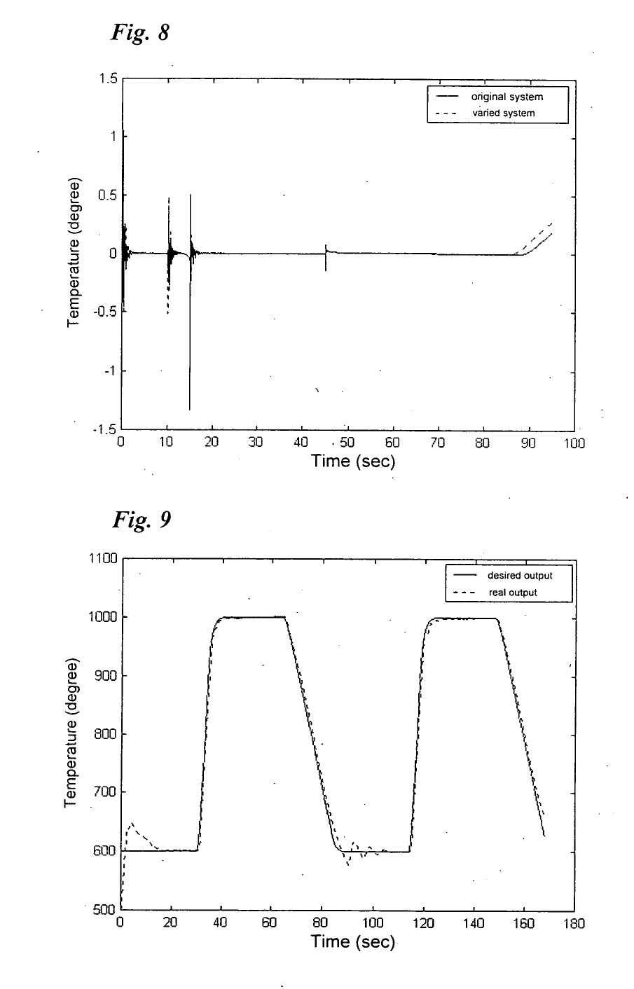

In order to verify adaptive capacity of the proposed controller in case of a variation in a system, a result of application of 10% variation to a model parameter of a system in the method of the present invention is represented in FIG. 8. Referring to FIG. 8, a dotted line is the result under a variation, and a solid line is a result under an original model. Comparing the results indicates that there is no difference in performance. In other words, a variation of a system can be handled properly when a method according to embodiment 1 is employed.

[Embodiment 2]

The method for temperature control in a rapid thermal processing system employing the adaptive control according to the present invention is applied to a quintuple ring type 8 inch RTP system. For input, tied 5 lamp rings with single input and output type is used, and for output, a pyrometer measuring at the center of a wafer is used.

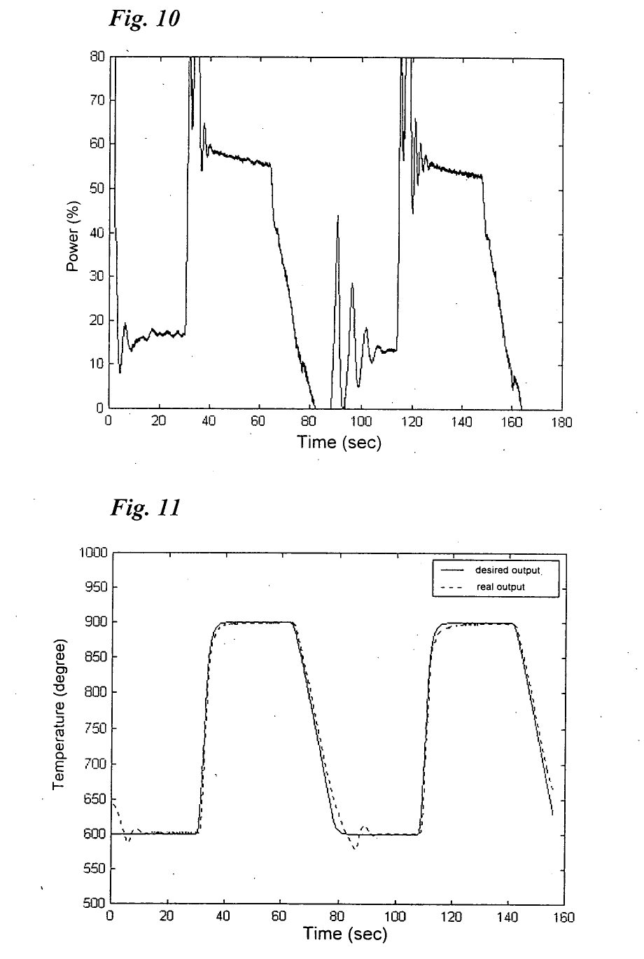

\overline{ƒ}=−300, \overline{g}=10 in the Mathematical equation 16 and gₗ=0.01 in the Mathematical equation 17. The number of each local domain for ƒ, g are 2 and their centers are at 600° C. and a steady state temperature of desired reference output, respectively. The size of a lattice of an axis is set to the difference between 600° C. and a steady state temperature of desired reference output. When the steady state temperature of desired reference output is 1000° C., a reference output and a real output are represented in FIG. 9 together. Referring to FIG. 9, a solid line represents a desired output and a dotted line represents a real output. FIG. 9 shows that the error at a steady state is very small. The input in this case is shown in FIG. 10.

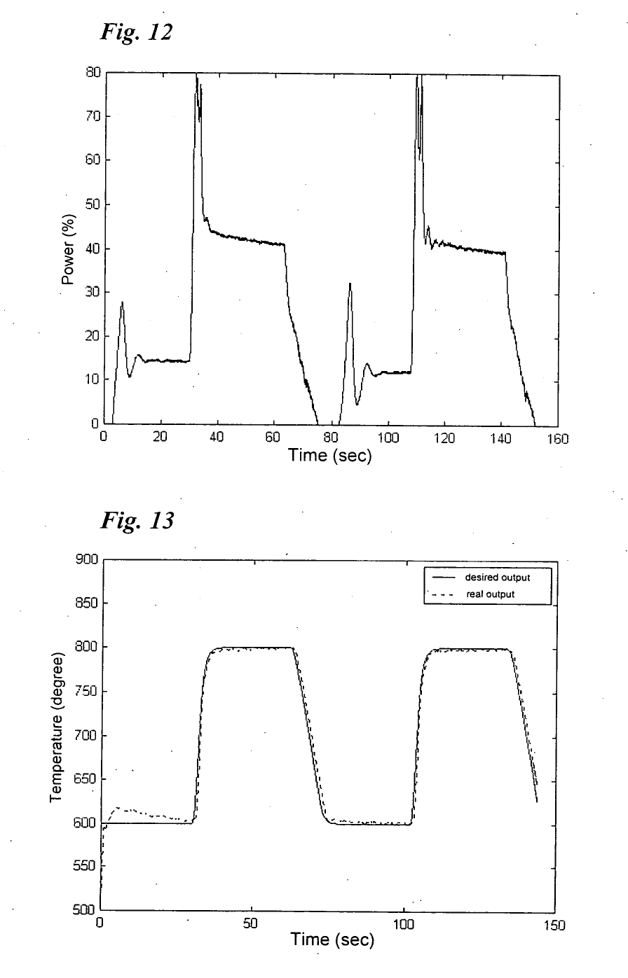

FIGS. 11 and 12 show a real output and its corresponding input when the steady state temperature of reference output is 900° C., respectively.

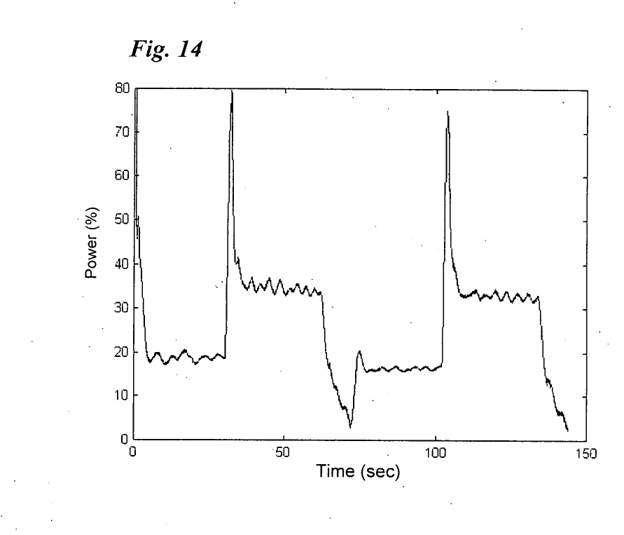

FIGS. 13 and 14 show a real output and its corresponding input when the steady state temperature of reference output is 800° C., respectively.

As shown in the drawings, embodiment 2 of the present invention shows good results consistently at diverse steady state temperatures of reference outputs. Furthermore, referring to FIGS. 9, 11 and 13, the same trajectory is repeated twice and the second lo trajectory shows a minor variation in a system due to lamp heat generated in the first trajectory. The apparatus and method according to the present invention follows desired output nicely by employing an adaptive control in this case. In other words, a variation in a real system can be handled properly when a method according to embodiment 2 is employed.

### Industrial Applicability

A rapid thermal processing system shows strong nonlinearity, and parameters of a controller have to be tuned according to operating point of a reference trajectory. However, a tuning in off-line can not maintain the performance due to time-varying characteristics. According to the present invention, a high performance control capability can be maintained by on-line tracking precisely to a reference trajectory irrespective of operating point and time-varying characteristics.

What is claimed is:

1. A temperature control apparatus of a rapid thermal processing system which controls power of a lamp in order to provide a uniform temperature distribution across a wafer with minimal temperature variation while the temperature of the wafer tracks precisely the temperature curve predetermined in a manufacturing process, the temperature control apparatus comprising:
a controller which calculates a proper power of a lamp using an approximated feedback linearization;
a nonlinear dynamic estimator which estimates unknown dynamic portion of the processing system on-line; and
a parameter adaptator which adapts parameters of the nonlinear dynamic estimator.

2. The temperature control apparatus of a rapid thermal processing system of claim 1, wherein the nonlinear dynamic estimator uses a universal function approximator.

3. The temperature control apparatus of a rapid thermal processing system of claim 1, which contains an adaptator in which a certain proportion of multiplication of a function which comprises a local function, a measured temperature and middle points of local ranges, and an output error is a variation ratio of a parameter of a function estimator.

4. The temperature control apparatus of a rapid thermal processing system of claim 3, wherein the adaptator stops when the adaptation value of a parameter estimating a function which is multiplied to an input is outside of predetermined function value or the a rate of change on the border of a range points out of the range.

5. A method of temperature control of a rapid thermal processing system according to claim 2, the method comprising the steps of:
changing parameters reflecting tracking errors between a real output and a desired output in the parameter adaptator;
identifying the dynamic characteristics of the system in the nonlinear dynamic estimator using the parameters; and
performing temperature control of the rapid thermal processing system by obtaining a control input in the controller based on the estimated values.

6. The method of temperature control of a rapid thermal processing system of claim 5, further comprising the steps of:
making a local function representing a local domain by normalizing a Gaussian function in which a division is made based on a reference temperature in the universal function approximator, the center of function is a middle point of each local division, and a measured temperature is a variable;
approximating to a linear function in the local domain; and
making an estimating function by adding function's after multiplying the linear functions with a local function.

7. The method of temperature control of a rapid thermal processing system of claim 5, further comprising the steps of:
making a local function representing a local domain by normalizing a Gaussian function in which a division is made based on a reference temperature in the universal function approximator, the center of function is a middle point of each local division, and a measured temperature is a variable;
approximating to a constant parameter in the local domain; and
making an estimating function by adding functions after multiplying the constant parameter with a local function.
